(19) United States
(12) Patent Application Publication
(10) Pub. No.: US 2023/0405620 A1
(43) Pub. Date: Dec. 21, 2023

(54) CLEANING MACHINE

(71) Applicant: SANTOEMMA S.R.L., Pero (MI) (IT)

(72) Inventor: MASSIMILIANO SANTOEMMA, Bareggio (MI) (IT)

(73) Assignee: SANTOEMMA S.R.L., Pero (MI) (IT)

(21) Appl. No.: 18/036,210

(22) PCT Filed: Nov. 10, 2021
(86) PCT No.: PCT/IB2021/060400

§ 371 Date: May 10, 2023

(30) Foreign Application Priority Data
Nov. 12, 2020 (IT) 102020000027125

(51) Int. Cl. B05B 7/24

(52) U.S. Cl. CPC B05B 7/2416; B05B 7/2464; B05B 7/2491

(57) ABSTRACT

Cleaning machine (100) comprising a nebuliser device (10) for nebulising a liquid product (115), a tank (110) containing said liquid product (115), an intake part (120) comprising at least one waste air vent (125), wherein said nebuliser device (10) comprises a dispenser (20) for dispensing said liquid product (115), a first connecting duct (211) which connects in fluid communication said tank (110) with said dispenser (20), a second duct (225) which connects in air-flow communication said at least one waste air vent (125) of said intake part (120) with said dispenser (20), wherein said dispenser (20) comprises a hollow body (21) comprising an inner cavity (25) connected in air-flow communication with said second duct (225), a dispensing tube (30) connected in fluid communication with said first duct (211), wherein a space is provided forming a nebulisation area (40) arranged at a mouth of an outlet pass-through opening of said dispensing tube (30) and at a mouth of a pass-through outlet opening of said inner cavity (25).

The present invention relates to a cleaning machine.

In the background art, cleaning machines capable of nebulising a liquid product by means of a compressor are known. It is possible to obtain a nebulised mixture of air and liquid product containing very fine particles of liquid product, typically about 50 microns in diameter or less. These machines comprise a dispensing gun adapted to mix compressed air and the liquid product to obtain nebulisation. Liquid droplets are created by the mechanical action of compressed air striking against a liquid stream, generating liquid particles with the appearance of very small droplets.

Disadvantageously, the compressor is heavy, energy-intensive and occupies a large volume.

Cleaning machines also exist on the market, with or without a compressor, provided with a hydraulic pump whose pressure allows to nebulise a liquid into very fine particles. The pump pushes the liquid into a suitable circuit which ends with one or more nozzles for nebulisation. By using suitable pressure and sufficiently small nozzles, it is possible to nebulise the liquid into fine particles, e.g., with a diameter of 100 microns or less. The hydraulic pump pressurises the liquid to a pressure between 25 and 30 bar, for example, and the machine is provided with a nebulising gun with a suitable nozzle. Liquid droplets are obtained by forcing a liquid through very small holes in suitable nebulising nozzles, which is made possible by the pressure exerted by a suitable hydraulic pump. The diameter of the particles decreases with increasing pump pressure and decreasing nozzle section. To obtain small droplets (e.g., with a diameter of the order of 50 microns or less) it is necessary to have fairly high pressures (generally at least around 10-20 bar) which require an expensive pump and disadvantageously small nozzles, which are likely to become clogged over time by limescale or impurities contained in the liquid. Disadvantageously, the hydraulic pump is heavy, occupies a large volume and is energy-intensive.

In all the cleaning machines of the background art which are provided with at least one suction motor, it is evident that the air sucked by the motor and which is removed from a dirt container exits the motor itself and is reintroduced into the environment, possibly passing through filters, but without disadvantageously using it for other purposes.

Disadvantageously, the cleaning machines of the background art perform the nebulisation function by virtue of a suitable air compressor or a hydraulic pump. In fact, the nebulisation of a liquid in very fine particles can be performed by acting on the liquid by means of the pressure exerted by an air compressor, or by means of the pressure exerted by a hydraulic pump.

The object of the present invention is to obtain a cleaning machine comprising a function for nebulising a liquid product, for example sanitiser, which is low in cost and small in size.

In accordance with the invention, such an object is achieved with a cleaning machine according to claim 1.

Other features are provided in the dependent claims.

The features and advantages of the present invention will be more apparent from the following description, which is to be understood as exemplifying and not limiting, with reference to the appended schematic drawings, in which:

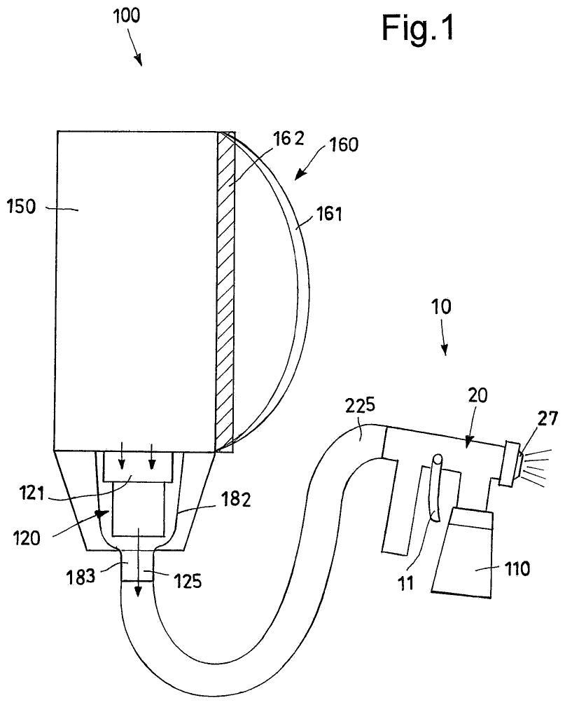

FIG. 1 is a schematic view of a first embodiment of a cleaning machine according to the present invention;

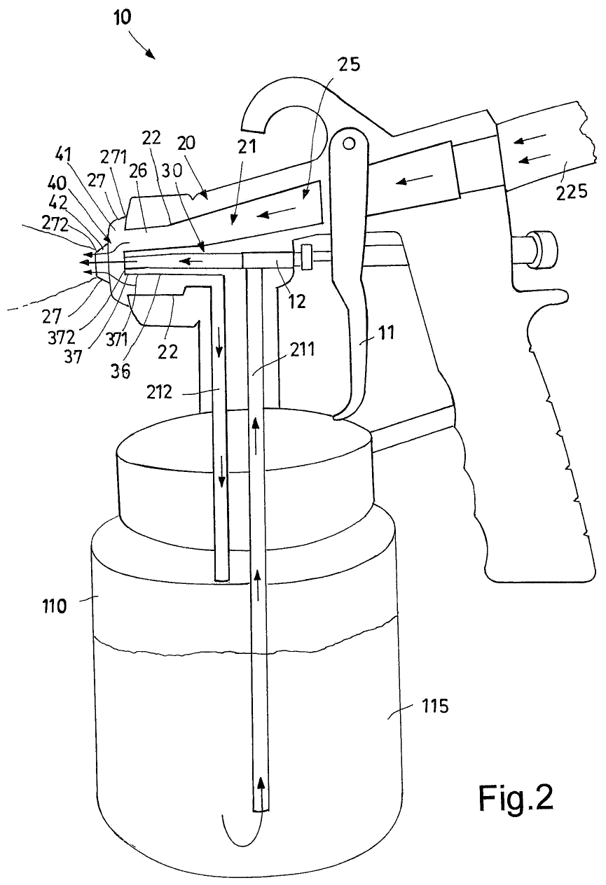

FIG. 2 is a schematic sectional view of a nebuliser device of the cleaning machine of FIG. 1;

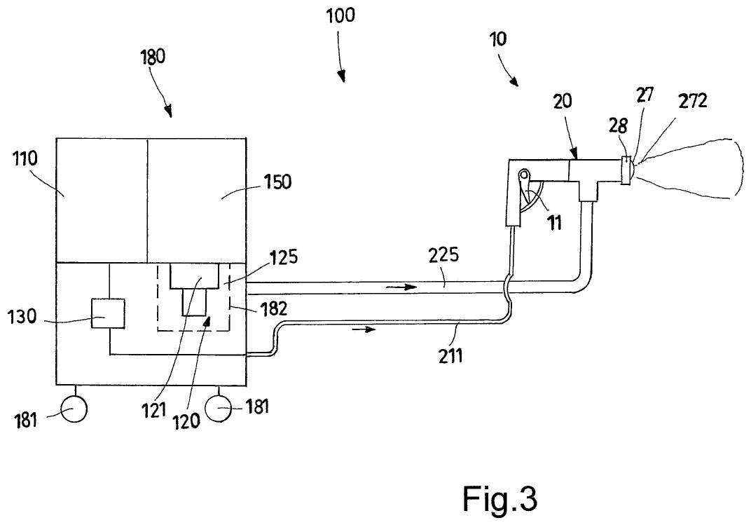

FIG. 3 is a schematic view of a second embodiment of the cleaning machine according to the present invention;

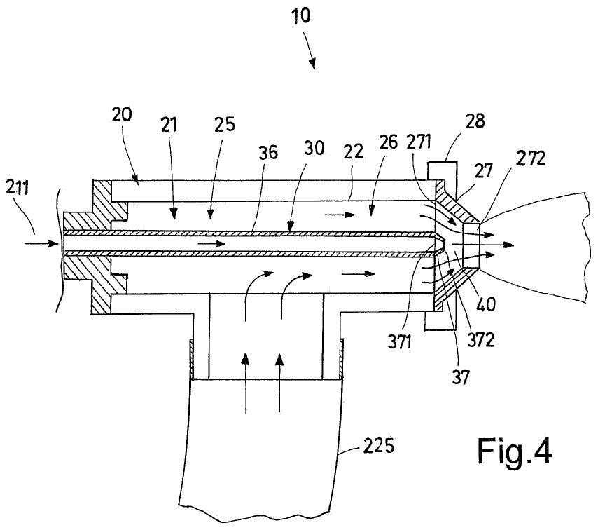

FIG. 4 is a schematic sectional view of a nebuliser device of the cleaning machine of FIG. 3;

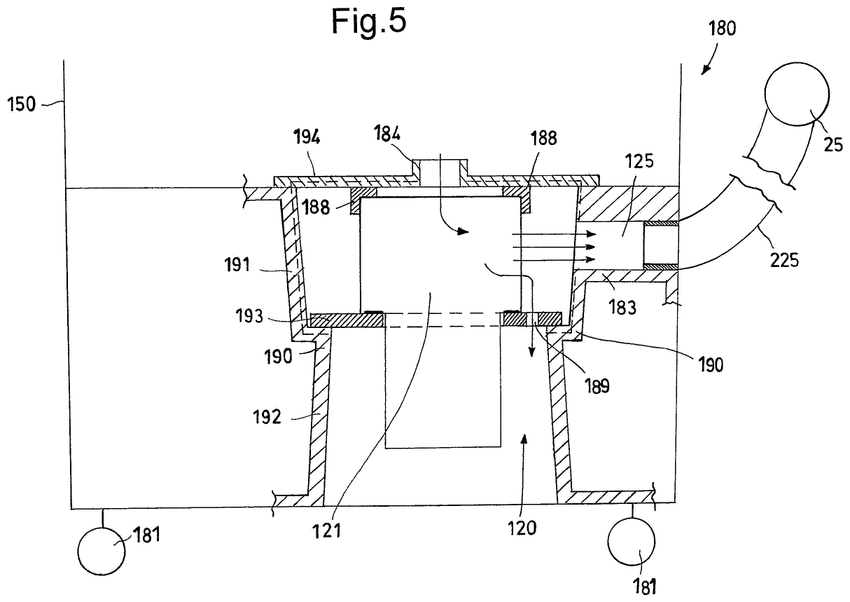

FIG. 5 is a schematic sectional view of an intake part of the cleaning machine according to the present invention;

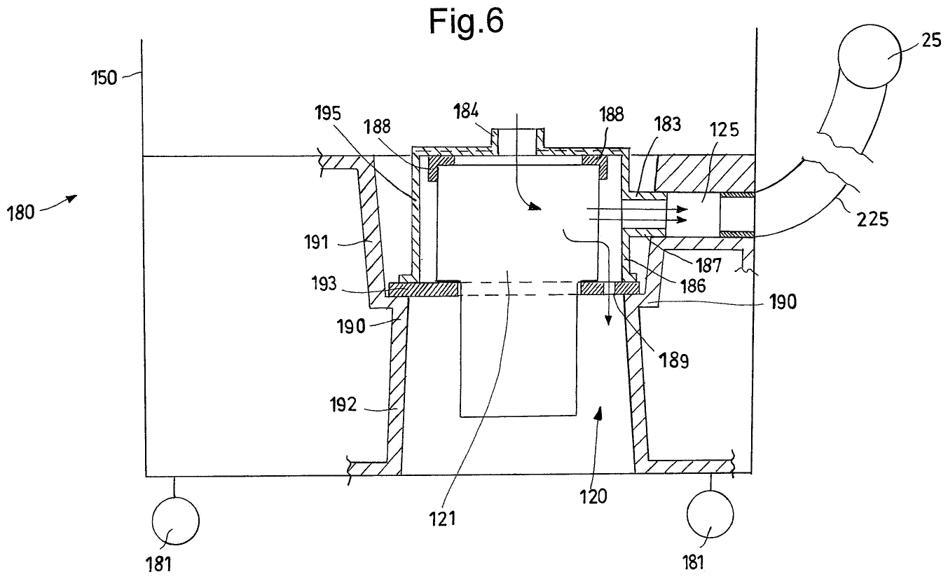

FIG. 6 is a schematic sectional view of an alternative intake part of the cleaning machine according to the present invention;

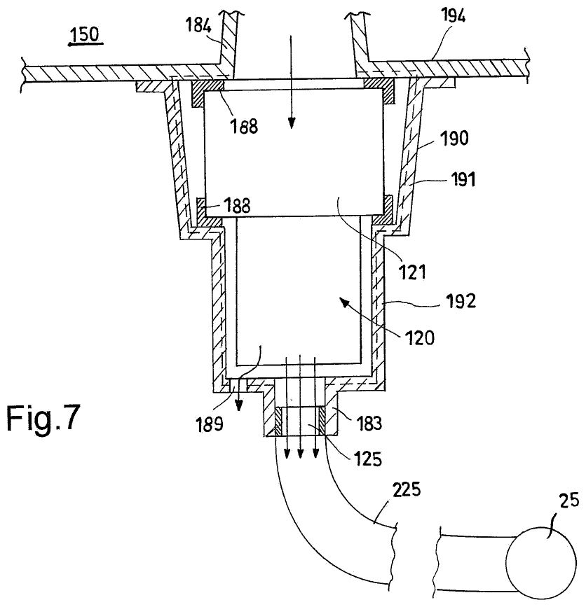

FIG. 7 is a schematic sectional view of a further alternative intake part of the cleaning machine according to the present invention;

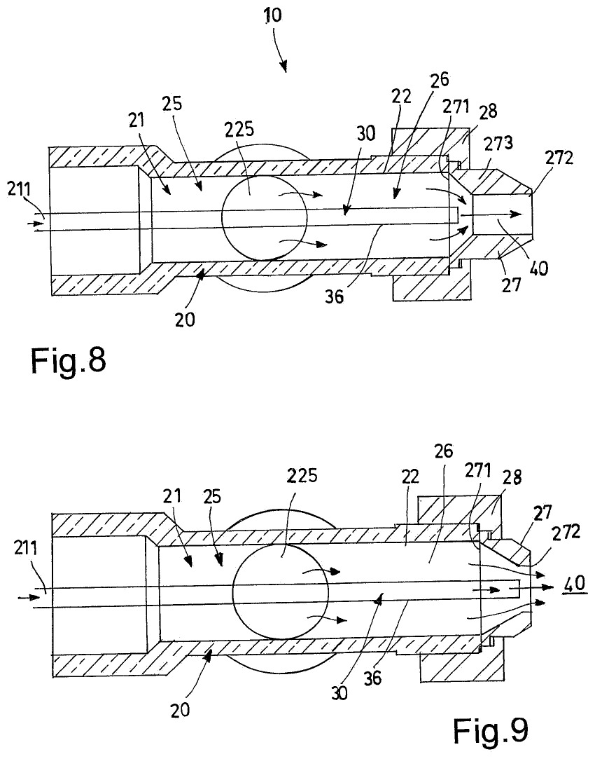

FIG. 8 is a schematic sectional view of an alternative nebuliser device;

FIG. 9 is a schematic sectional view of a further alternative nebuliser device;

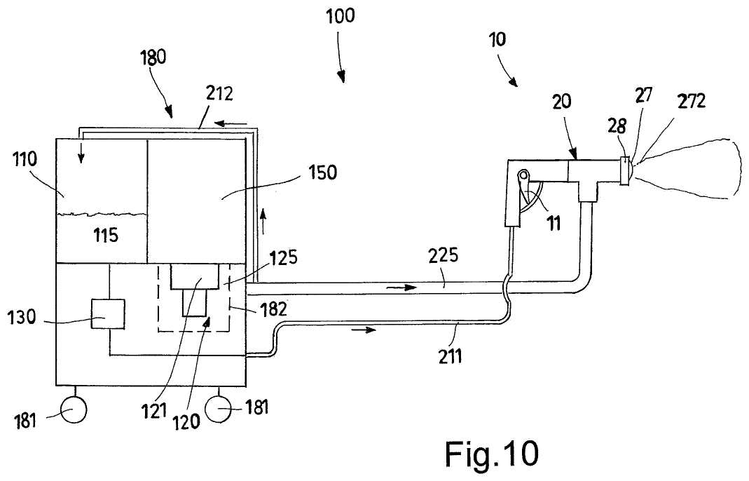

FIG. 10 is a schematic view of an alternative cleaning machine according to the present invention;

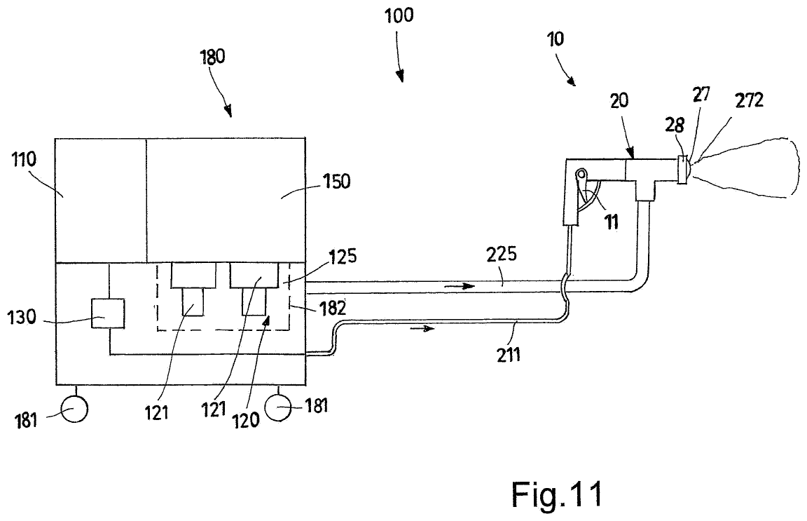

FIG. 11 is a schematic view of yet another alternative cleaning machine comprising two motors;

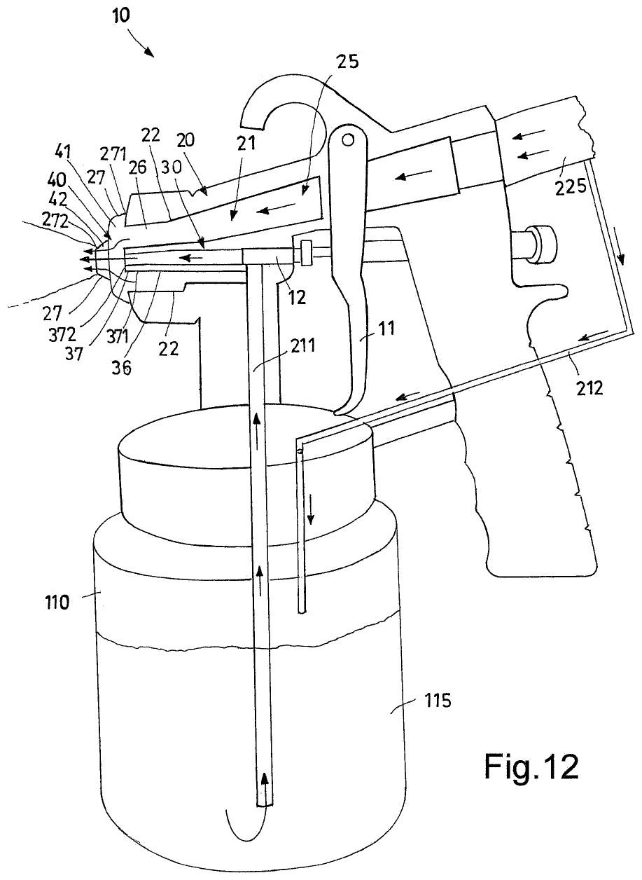

FIG. 12 is a schematic view of yet another alternative nebuliser device;

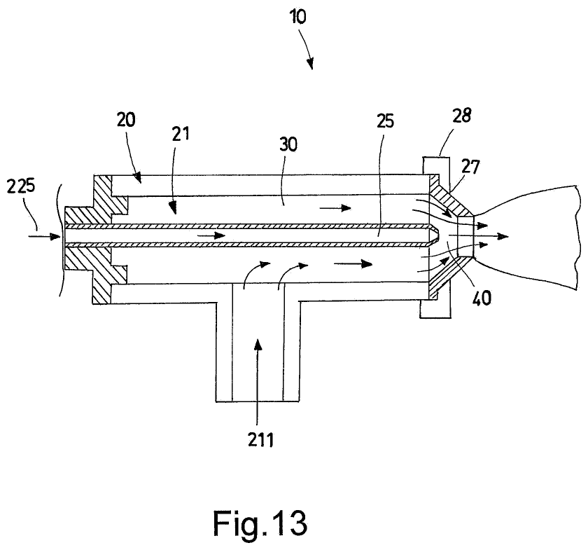

FIG. 13 is a schematic view of a further alternative of the nebuliser device.

With reference to the above figures, a cleaning machine 100 is shown which does not comprise any compressors.

The cleaning machine 100 is comprised in the following types: domestic, professional or industrial vacuum cleaners or wet vacuums, provided with at least one suction motor 121; “injection-extraction” machines, provided with at least one suction motor 121 and a circuit for spraying liquid and cleaning accessories, connected to the machine by means of special flexible connection tubes; cleaning and sanitising machines functioning with the “spray-rinse-suction” or “foam-rinse-suction” systems, provided with a circuit for spraying product in the form of foam or liquid and at least one suction motor 121; self-contained machines, suitable for carpeted or non-carpeted surfaces, provided with at least one suction motor 121 and a washing unit placed directly below the machine body, possibly with one or more rotating brushes; floor cleaning machines, specific for hard floors, provided with at least one suction motor 121 and a washing unit placed directly below the machine body, possibly provided with one or more rotating brushes; different types of cleaning machines, as long as they are provided with at least one suction motor 121.

The present invention relates to the possibility of obtaining said cleaning machine 100 which nebulises a liquid product in very fine particles, without the machine using an air compressor for such a purpose.

In all the embodiments, the machine 100 according to the present invention allows the nebulised liquid to be sprayed through a manual dispenser 10 such as a dispensing gun, which allows the operator to direct the flow in the desired manner.

Preferably, the machine 100 does not even comprise a hydraulic pump 50 as shown in FIGS. 1 and 2 according to a first embodiment.

As shown in FIGS. 1-9, the cleaning machine 100 comprises a nebuliser device 10 for nebulising a liquid product 115, a tank 110 containing said liquid product 115, in which said liquid product 115 is maintained in a liquid state inside said tank 110, an intake portion 120 comprising at least one waste air vent 125.

The liquid product 115 is a cleaning or sanitising product or simply a liquid which is to be nebulised for cleaning.

Said nebuliser device 10 comprises a dispenser 20 for dispensing said liquid product 115, a first connecting duct 211 which connects in fluid communication said tank 110 with said dispenser 20, a second connecting duct 225 which connects in air-flow communication said at least one waste air vent 125 of said intake part 120 with said dispenser 20.

As shown in particular in FIGS. 2 and 4, said dispenser 20 comprises a hollow body 21 comprising an inner cavity 25 connected in air-flow communication with said second duct 225, a dispensing tube 30 which is connected in fluid communication with said first duct 211, in which at least one portion of said dispensing tube 30 projects inside at least one portion of said inner cavity 25. The liquid product 115 is forced into the first connecting duct 221 at a pressure higher than atmospheric pressure.

A space forming a nebulisation area 40 is provided between an outlet pass-through opening of said dispensing tube 30 and an outlet pass-through opening of said inner cavity 25, in which said nebulisation area 40 is arranged inside said inner cavity 25.

It should be noted that the machine 100 advantageously does not comprise any compressor which is adapted to increase the air pressure before introducing it into the second duct 225 which connects in air-flow communication the intake part 120 of the machine 100 with the dispenser 20 of the machine 100.

Even more preferably and as shown in particular in FIGS. 2 and 4, said inner cavity 25 comprises at least one hollow cylindrical portion 26 comprising inner walls 22 of said hollow body 21.

In the first example shown in FIG. 2, the inner cavity 25 comprises only one hollow cylindrical portion 25.

In the second embodiment shown in FIG. 4, the inner cavity 25 consists entirely of the hollow cylindrical portion 26.

Said dispensing tube 30 comprises at least one hollow cylindrical portion 36, in which said at least one hollow cylindrical portion 36 of said dispensing tube 30 is arranged inside said at least one hollow cylindrical portion 26 of said inner cavity 25.

In the first embodiment shown in FIG. 2, the dispensing tube 30 comprises only one hollow cylindrical portion 36.

In the second embodiment shown in FIG. 4, the dispensing tube 30 consists entirely of the hollow cylindrical portion 36.

The second embodiment shown in FIG. 4 shows that the inner cavity 25 is a T-connection also comprising an inlet channel connected by air-flow with the second connecting duct 225.

Even more preferably and advantageously in order to direct and increase the air velocity in the nebulisation area 40, said inner cavity 25 comprises at least one hollow portion in truncated-cone shape 27.

Even more preferably said dispensing tube 30 comprises a hollow portion in truncated-cone shape 37.

Said at least one hollow portion in truncated-cone shape 27 of said inner cavity 25 comprises an open greater geometrical base forming a first pass-through opening 271 with a greater width which matches with a width of said at least one hollow cylindrical portion 26 of said inner cavity 25 and an open smaller geometrical base forming a second pass-through opening 272 with a smaller width which is said outlet pass-through opening of said hollow body 21 of said dispenser 20.

Said hollow portion in truncated-cone shape 37 of said dispensing tube 30 comprises an open greater geometrical base forming a first pass-through opening 371 with a greater width which matches with a width of said at least one hollow cylindrical portion 36 of said dispensing tube 30 and an open smaller geometrical base forming a second pass-through opening 372 with a smaller width which is said outlet pass-through opening of said dispensing tube 30.

Even more preferably and advantageously to create a uniform flow of both air and fluid, said at least one hollow cylindrical portion 26 of said inner cavity 25 comprises a circular transversal section, furthermore said one hollow cylindrical portion 36 of said dispensing tube 30 comprises a circular transversal section, furthermore it is provided that respective geometric axes of symmetry of each of said hollow cylindrical portions 26, 36 are congruent.

As shown in FIGS. 1 and 2, the first embodiment provides that there is no hydraulic pump 130 adapted to increase the pressure of the liquid product 115. The liquid product 115 is maintained at a pressure higher than atmospheric pressure inside the tank 110 by means of an air outlet duct 212. The outlet duct 212 comprises a hollow upper end in air-flow communication with the inner cavity 25 and a lower end in air-flow communication with the tank 110. Said inner cavity 25 comprises said outlet duct 212. The lower end of the outlet duct 212 ends outside the liquid product 115 in liquid state contained in the tank 110, so that the air from the outlet duct 212 is introduced into the space of the tank 110 comprising air. The upper end of the outlet duct 212 is arranged at a distance from the nebulisation area 40.

The entry of air from the outlet duct 212 into the tank 110 causes a pressure increase of the gas contained in the tank 110, increasing the internal pressure of the tank 110 and consequently causing the liquid product 115 to remain inside the tank 110 at a pressure higher than atmospheric pressure.

The first connecting duct 211 has one end which is immersed in the liquid product 115 contained inside the tank 110.

This first embodiment is preferable, as the machine 100 advantageously lacks the hydraulic pump 130, thereby the machine 100 is even less energy-intensive, even lighter and even smaller in volume.

Even more preferably, the first embodiment in FIG. 2 shows the possibility of providing two hollow portions in truncated-cone shape 27 of said at least one hollow portion in truncated-cone shape 27, in which a first hollow portion in truncated-cone shape 27 gradually reduces a width of the inner cavity 25 to a first width, in which a second hollow portion in truncated-cone shape 27 gradually reduces said first width of the inner cavity 25 to a second width of a smaller width than the first width, so that the nebulisation area 40 comprises a first zone 41 and a second zone 42. Said first zone 41 is wider with respect to the second zone 42. Said first zone 41 of the nebulisation area 40 provides that the liquid product 115 is introduced by the dispensing tube 30 into the inner cavity 25 creating a mixture with the air contained therein. Said second zone 42 of the nebulisation area 40 advantageously increases a velocity of the nebulised mixture prior to being released into the atmosphere through the outlet pass-through opening of said inner cavity 25. The outlet pass-through opening of said inner cavity 25 is the second pass-through opening 272 of the second hollow portion in truncated-cone shape 27.

As instead shown in FIGS. 3 and 4, the second example provides that the machine 100 comprises a hydraulic pump 130. Said hydraulic pump 130 is connected to said tank 110 and to said first duct 211, in which said hydraulic pump 130 keeps said liquid product 115 under pressure at a pressure higher than said atmospheric pressure. Said hydraulic pump 130 advantageously allows to continuously supply the dispensing device 10, so as to have a virtually unlimited spray autonomy of the nebulised mixture.

As shown in particular in FIGS. 1-4, said dispenser 20 comprises at least one actuator 11 mounted between said first duct 211 and said dispensing tube 30. Said actuator 11 controls a fluid flow rate of said liquid product 115. For example, said actuator 211 is a lever acting on a valve 12 arranged between said first duct 211 and said dispensing tube 30 to regulate the inlet flow between said first duct 211 and said dispensing tube 30.

The dispensing device 10 is in the form of a gun, as shown in FIGS. 1-4 to advantageously facilitate a directing of spray towards an area to be cleaned by an operator handling said machine 100.

As shown in FIG. 1, the first embodiment is advantageously smaller and allows to provide, for example, that the machine 100 comprises a container 150 for sucking dust or liquids or waste which can be worn by means of a harness 160 by the operator. The harness 160 comprises at least two shoulder straps 161 to ensure that the container 150 can be worn on the operator's shoulders as if it were a rucksack and that the operator can direct the nebulisation flow while holding the nebuliser device 10. In this first embodiment it can be noted that the tank 110 is mounted with the dispenser 20 and the intake part 120 is mounted with the container 150.

It is further possible to provide that a portion of the container 150 facing the operator's shoulders may have a padded surface 162 forming part of the harness 160.

As shown in FIGS. 3 and 4, the machine 100 according to the second embodiment instead mounts together the tank 110 and the container 150 for the sucked waste to form a carrier unit 180. Providing also for the presence of the hydraulic pump 130, it is provided that the carrier unit 180 is provided with wheels 181 to facilitate transport by the operator. The operator holds the dispensing device 10 and suitably directs it towards the zones to be nebulised.

As shown in FIG. 4, it should be noted that the second duct 225 comprises an end which opens into the inner cavity 25 at a distance from the nebulisation area 40 so as to facilitate the supply of air to the nebulisation area 40.

As shown in FIG. 4, it should be noted that the portion in truncated-cone shape 27 is connected to the cylindrical portion 26 by means of a ring nut 28.

As shown in FIGS. 5-7, the intake part 120 of the machine 100 always comprises at least one suction motor 121, which is used to suction dust or liquids, which are recovered inside at least said container 150 which is a dirt recovery tank.

During the dirt recovery operations, the container 150 is kept under vacuum by virtue of the action of the suction motor 121, which removes air from the container 150, keeping it always under vacuum. The container 150 is put in communication with the outside by means of connection tubes and suitable suction nozzles or accessories which come into contact with the surfaces to be cleaned and which serve to suction dust or liquids inside the recovery tank.

When the machine 100 is of the vacuum cleaner type, the container 150 may be provided with a bag for containing dust. In any event, both for vacuum cleaners and for the other types of cleaning machines 100 mentioned above, there may be filters interposed between the suction motor 121 and the container 150, which serve to prevent fine dust from being sucked directly into the motor 121 of the intake part 120.

As shown in FIG. 5, the vacuum cleaner 100 provides that the suction motor 121 of the intake part 120 is enclosed in a container 190 formed by suitably shaped components. The container 190 has the purpose of conveying the air output from the motor 121 towards the second duct 225 by means of said at least one waste air vent 125, in order to advantageously use it for nebulisation.

As shown in FIGS. 5-7, the suction motor 121 is housed inside the container 190. The container 190 comprises at least one inlet pass-through opening 184 and at least one outlet pass-through opening 183 which is said at least one waste air vent 125.

The inlet pass-through opening 184 channels air from the dirt container 150 to the motor 121, while the outlet pass-through opening 183 channels the vent air towards the second duct 225. The container 190 comprises a bearing surface which may be the same load-bearing structure of the body of the machine 100 as shown in FIG. 7, or a structure itself rigidly fixed with the container 190 as shown in FIGS. 5 and 6.

As shown in FIGS. 5-7 even more preferably, vibration damping and/or sealing gaskets 188 are provided between the container 190 and the motor 121 which allow to attenuate vibrations transmitted from the motor 121 to the body of the machine 100 during the operation thereof. Other means could be used instead of gaskets, such as adhesives or sealants of various kinds.

As shown in FIGS. 5 and 6, most of the waste air sucked from the dirt container 150 by the motor 121 of the intake part 120 exits from said outlet pass-through opening 183.

As shown in FIG. 6, the outlet pass-through opening 183 is arranged laterally to the motor 121 and an opening flange 187 is connected with said second connecting duct 225.

As shown in FIG. 5, the container 190 comprises an upper lateral portion 191, a lower lateral load-bearing portion 192 comprising a support surface for the motor 121, an upper portion 194 comprising the inlet pass-through opening 184 connected in air-flow communication with said dirt container 150, a disc 193 mounted above the support surface which supports the motor 121 and is supported by the lower lateral load-bearing portion 192. The upper lateral portion 191 comprises a flange which opens into the outlet pass-through opening 183 which is the waste air vent 125.

As shown in FIG. 6, the container 190 comprises a lid-shaped structure 195 in place of the upper portion 194. The lid-shaped structure 195 comprises an upper portion comprising the inlet pass-through opening 184. The lid-shaped structure 195 is supported by the disc 193 and comprises a lateral wall 186 comprising an opening flange 187 which reduces a transversal section width of the outlet pass-through opening 183 which is the air vent 125 allowing the opening flange 187 to be connected directly with the second duct 225.

Preferably, the outlet pass-through opening 183 is obtained from the opening flange 187 as shown in FIG. 6.

More generally, the machine 100 comprises the dirt container 150 and said intake part 120 comprises at least one motor 121 adapted to suction air from said dirt container 150, in which said at least one motor 121 is housed inside the container 190 of the intake part 120. Said container 190 comprises at least one inlet pass-through opening 184 for passing air from said dirt container 150 towards said at least one motor 121 and said at least one outlet pass-through opening 183, in which said at least one outlet pass-through opening 183 is said at least one waste air vent 125.

Said output pass-through opening 183 is arranged laterally to said at least one motor 121 as shown in FIGS. 5 and 6.

As shown in FIG. 7 said outlet pass-through opening 183 may be arranged below said at least one motor 121 and said at least one waste air vent 125.

As shown in FIG. 7 the container 190 is mounted with a lower wall of the dirt container 150. This lower wall of the dirt container 150 comprises a flanged outlet towards the inside of the dirt container 150. Said flanged outlet forms the inlet opening 184 of the container 190. Damping elements 188 form a pass-through disc which allows air to enter from the dirt container 150 to the container 190. The first upper lateral portion 191 is mounted with the lower wall of the dirt container 150 by means of a flanged portion. The lower lateral load-bearing portion 192 comprises a lower portion which opens with a flange which is said an outlet pass-through opening 183 which is the waste air vent 125 connected with the second duct 225.

Advantageously, the container 190 of FIGS. 5-7 allows to direct most of the waste air from the dirt container 150 to the second duct 225.

Preferably as shown in FIGS. 5 and 6 it is further provided that the container 190 comprises at least one safety pass-through hole 189 allowing a small amount of air to exit outside the container 190. The safety pass-through vent hole 189 is smaller with respect to the outlet pass-through opening 183.

As shown in FIGS. 5 and 6, the safety pass-through vent hole is hollowed out in the disc 193.

Alternatively, as shown in FIG. 7, the pass-through vent hole 189 is arranged near the outlet pass-through opening 183 and is hollowed out in the lower portion of the lower lateral load-bearing wall 192. The safety pass-through vent hole 189 puts in communication the inside of the container 190 with the outside of the container 190.

Said pass-through vent hole 189 is particularly useful for ensuring an air vent of the container 190 if abnormal operation prevents air from freely flowing through the outlet pass-through hole 183 and thus to the second duct 225.

The outlet pass-through opening 183 is sized to allow most of the air sucked by the motor freely flow through the second duct 225.

For example, the safety pass-through vent hole 189 may have a section equal to ⅙th of the section of the second duct 225. Alternatively, other dimensions are possible, all of which are adapted to ensure a sufficient vent.

In FIGS. 5-7, the pass-through vent hole 189 is free.

The above-described invention may provide the presence of further connecting or filtering components useful for conveying or filtering the air exiting from said at least one outlet opening 183, before it enters the second duct 225.

Advantageously, the cleaning machine 100 comprises a liquid nebulisation function, is low cost and small in size.

Advantageously, the cleaning machine 100 is capable of both cleaning and nebulising a liquid in the form of a mixture of air and very small liquid droplets.

Advantageously, the mixture of liquid and air generated by the machine 100 can be sprayed in closed environments with the aim of diffusing a liquid, e.g., sanitiser, into the same.

Advantageously, the same mixture can also be directed directly onto surfaces in order to distribute a liquid product thereon in the form of a thin layer which uniformly covers the surfaces.

Advantageously, the nebulised solution allows to reach every point in the environment or on surfaces, uniformly distributing the product, in the desired amount and without waste.

Advantageously, the air coming from the machine 100 exerts a pressure on the liquid contained in the tank 110, of the order of about 0.1 to 0.2 bar. This pressure allows the liquid product 115 to rise through the rising channel, which is the second duct 225.

Advantageously, a nebulisation jet of the air mixture to the liquid product 115 comprises very small particles which take the form of very fine droplets. Using air jets of 30-50 litres per second and by sizing the liquid and air passage sections and the nebulisation area 40 it is possible to obtain a very fine mixture jet. Such a jet can reach a distance of 3-4 metres from the operator. The amount of nebulised liquid in the mixture jet is adjustable by virtue of a flow regulator which intercepts the liquid passage.

By appropriately sizing the sections of the inner cavity 25 and the dispensing tube 30, it is possible for the liquid to be suctioned by Venturi effect from the tank 110 thereof.

Advantageously, if the cleaning machine 100 is of the vacuum cleaner or wet vacuum type, it can operate even if it does not contain in the machine body any tank to contain the liquid 115, nor any pump 130 and a hydraulic circuit to push the liquid to the nebuliser device 10.

Alternatively, it is possible to provide that the cleaning machine 100 comprises a hydraulic pump 130, in which the hydraulic pump 130 continuously feeds the spray gun 10, so as to have a virtually unlimited spray autonomy during nebulisation.

Alternatively, it is possible to provide other geometric shapes of the inner cavity 25 and the dispensing tube 36, for example it is possible to provide for them to have truncated-cone shape.

Alternatively said at least one hollow cylindrical portion 26 of said inner cavity 25 comprises an elliptical transversal section, furthermore said one hollow cylindrical portion 36 of said dispensing tube 30 comprises an elliptical transversal section.

Alternatively, it is provided that the respective geometric axes of symmetry of each of the hollow cylindrical portions 26, 36 are not congruent.

Alternatively, it is provided that the respective geometric axes of symmetry of each of the hollow cylindrical portions 26, 36 are parallel to each other.

Alternatively, if the motor 121 is mounted by means of locking flanges integrated in the load-bearing structure thereof, such as perforated tabs, at least one part of the fixing of the container 190 could be replaced by simple fixing screws. In each case, the motor 121 is fixed with respect to the body of the machine 100.

Alternatively, the safety pass-through vent hole 189 may be replaced by several holes or slots of any shape. The pass-through vent hole 189 may have a free passage, or a valve, or a normally closed passage by means of a sprung plug which opens the passage section of the pass-through vent hole 189 only when the pressure inside the container 190 exceeds a safety value, upon the occurrence of an obstruction along the second duct 225. The presence of the pass-through vent hole 189 also makes it advantageous not to overly raise the temperature inside the container 190.

Alternatively, the pass-through vent hole 189 may be arranged differently, for example the pass-through vent hole 189 could be located near the second duct 225 or above the second duct 225, or near the body of the machine 100.

Alternatively, it may be provided that the pass-through vent hole 189 may be arranged at any point on the walls of the container 190.

Alternatively, a pass-through vent hole 189 may be provided near the nebulisation area 40.

Alternatively, as shown in FIG. 11, the machine 100 may use one or more suction motors 121. In the case of several motors 121, these can be cascaded or connected in parallel. For parallel motors 121, each motor 121 is connected to the dirt container 150 so as to suction air from the dirt container 150.

Alternatively, as shown in FIG. 11, one of the motors 121 could be preferentially used to supply the air required for nebulisation. In this case said at least one outlet pass-through opening 183 receives air from a specific motor 121 only.

Alternatively, each motor may contribute to the generation of the air required for nebulisation. In this case the container 190 delimits said one or more motors 121.

Alternatively, said liquid product 115 is pushed into the first connecting duct 211 at a pressure lower than an atmospheric pressure and is maintained in a liquid state inside said tank 110. In this case, air is extracted from the tank 110 by Venturi effect.

Alternatively, said hollow cylindrical portion 26 of said inner cavity 25 comprises a prismatic transversal section.

Alternatively said at least one hollow cylindrical portion 36 of said dispensing tube 30 comprises a prismatic transversal section.

Alternatively as shown in FIG. 8 it is provided that said at least one hollow portion in truncated-cone shape 27 may comprise a tubular portion 273 which extends the nebulisation area 40. Hollow portion of truncated cone-shape 27 means that at least one portion of this hollow portion comprises a portion of truncated cone-shape 27, but other portions thereof may be tubular such as the tubular portion 273 shown in FIG. 8.

Alternatively, as shown in FIG. 9, the nebulisation area 40 is arranged at a mouth of the outlet pass-through opening of said dispensing tube 30 and at a mouth of the outlet pass-through opening of said inner cavity 25, in which said nebulisation area 40 is provided outside the inner cavity 25 and outside the nebuliser device 10.

Alternatively, said outlet duct 212 comprises a hollow upper end in air-flow communication directly with the second duct 225 and a lower end in air-flow communication with the tank 110.

Alternatively as shown in FIG. 10 said machine 100 comprises an air outlet duct 212 comprising one end connected in air-flow communication with said second duct 225 and another end which is connected in air-flow communication with said tank 110. This alternative advantageously does not have the hydraulic pump 130, since the air pressure conveyed by the outlet duct 212 is conveyed inside the tank 110 to increase the pressure of the liquid 115.

Alternatively as shown in FIG. 12 said outlet duct 212 is a tube outside the body of the dispenser 20. More in general, said nebuliser device 10 comprises the air outlet duct 212 comprising one end connected in air-flow communication with said inner cavity 25 and another end which is connected in air-flow communication with said tank 110.

Alternatively, the lower end of the outlet duct 212 ends in any point in the tank 110 which allows air to enter the tank 110.

Alternatively, said outlet pass-through opening 183 may be arranged at any point in the container 190 containing the motor 121.

Alternatively, as shown in FIG. 13 said dispensing tube 30 is outside said inner cavity 25, in fact it is sufficient that the space forming the nebulisation area 40 is arranged at the mouth of the outlet pass-through opening of said dispensing tube 30 and at the mouth of the outlet pass-through opening of said inner cavity 25.

Alternatively said dispensing tube 30 does not comprise any hollow portion in truncated-cone shape 37.

The invention thus conceived is susceptible to many modifications and variants, all falling within the same inventive concept; furthermore, all details can be replaced by equivalent technical elements. In practice, the materials used, as well as their dimensions, can be of any type according to the technical requirements.

1. Cleaning machine (100) comprising
a nebuliser device (10) for nebulising a liquid product (115),
a tank (110) which contains said liquid product (115),
an intake part (120) which comprises at least one vent for waste air (125),
wherein said nebuliser device (10) comprises
a dispenser (20) for dispensing said liquid product (115),
a first connecting duct (211) which connects in fluid communication said tank (110) with said dispenser (20),
a second duct (225) which connects in air-flow communication said at least one waste air vent (125) of said intake part (120) with said dispenser (20),
wherein said dispenser (20) comprises a hollow body (21) comprising
an inner cavity (25) connected in air-flow communication with said second duct (225),
a dispensing tube (30) connected in fluid communication with said first duct (211),
wherein a space forming a nebulisation area (40) is provided arranged at a mouth of an outlet pass-through opening of said dispensing tube (30) and at a mouth of an outlet pass-through opening of said inner cavity (25),
wherein said machine (100) comprises a dirt container (150) and wherein said intake part (120) comprises at least one motor (121) adapted to intake air from said dirt container (150), said at least one motor (121) being housed inside a container (190) of said intake part (120), wherein said container (190) comprises at least one inlet pass-through opening (184) for passing air from said dirt container (150) to said at least one motor (121) and at least one outlet pass-through opening (183), wherein said at least one outlet pass-through opening (183) is said at least one waste air vent (125),
wherein said container (190) comprises a pass-through vent hole (189) of smaller size with respect to said outlet pass-through opening (183), wherein said pass-through vent hole (189) opens the container (190) to the outside.

2. Cleaning machine (100) according to claim 1, characterised in that said nebulisation area (40) is arranged inside the inner cavity (25).

3. Cleaning machine (100) according to claim 1, characterised in that at least one portion of said dispensing tube (30) projects inside at least one portion of said inner cavity (25).

4. Cleaning machine (100) according to claim 3, characterised in that said inner cavity (25) comprises at least one hollow cylindrical portion (26) consisting of inner walls (22) of said hollow body (21),
wherein said dispensing tube (30) comprises at least one hollow cylindrical portion (36),
wherein said at least one hollow cylindrical portion (36) of said dispensing tube (30) is arranged inside said at least one hollow cylindrical portion (26) of said inner cavity (25).

5. Cleaning machine (100) according to claim 4, characterised in that
said inner cavity (25) comprises at least one hollow portion in truncated-cone shape (27),
wherein said at least one hollow portion in truncated-cone shape (27) of said inner cavity (25) comprises an open greater geometrical base forming a first pass-through opening (271) with a greater width which matches with a width of said at least one hollow cylindrical portion (26) of said inner cavity (25) and an open smaller geometrical base forming a second pass-through opening (272) with a smaller width which is said outlet pass-through opening of said hollow body (21) of said dispenser (20).

6. Cleaning machine (100) according to claim 5, characterised in that said dispensing tube (30) comprises a hollow portion in truncated-cone shape (37),
wherein said at least one hollow portion in truncated-cone shape (37) of said dispensing tube (30) comprises an open greater geometrical base forming a first pass-through opening (371) with a greater width which matches with a width of said at least one hollow cylindrical portion (36) of said dispensing tube (30) and an open smaller geometrical base forming a second pass-through opening (372) with a smaller width which is said outlet pass-through opening of said dispensing tube (30).

7. Cleaning machine (100) according to claim 4, characterised in that said at least one hollow cylindrical portion (26) of said inner cavity (25) comprises a circular transversal section, in that said hollow cylindrical portion (36) of said dispensing tube (30) comprises a circular transversal section, in that respective geometrical axes of symmetry of each of the cylindrical hollow portions (26, 36) are congruent.

8. Cleaning machine (100) according to claim 1, characterised in that said nebuliser device (10) comprises an air outlet duct (212) comprising an end connected in air-flow communication with said inner cavity (25) and another end which is connected in air-flow communication with said tank (110).

9. Cleaning machine (100) according to claim 1, characterised in that said machine (100) comprises an air outlet duct (212) comprising an end connected in air-flow communication with said second duct (225) and another end which is in air-flow communication with said tank (110).

10. Cleaning machine (100) according to claim 1, characterised in that it comprises a hydraulic pump (130), wherein said hydraulic pump (130) is connected with said tank (110) and with said first duct (211), wherein said hydraulic pump (130) keeps under pressure said liquid product (115) at said pressure higher than said atmospheric pressure.

11. Cleaning machine (100) according to claim 1, characterised in that it is provided with two hollow portions in truncated-cone shape (27) of said at least one hollow portion in truncated-cone shape (27), wherein a first a hollow portion in truncated-cone shape (27) gradually reduces a width of the inner cavity (25) to a first width, wherein a second a hollow portion in truncated-cone shape (27) gradually reduces said first width of the inner cavity (25) to a second width with a width smaller than the first width, so that the nebulisation area (40) comprises a first zone (41) and a second zone (42), wherein said first zone (41) is of a width larger than the second zone (42), wherein said first zone (41) of the nebulisation area (40) provides that the liquid of the liquid product (115) is introduced from the dispensing tube (30) into the inner cavity (25) creating a mixture with the air contained therein and said second zone (42) of the nebulisation area (40) adapted to increase a velocity of the nebulised mixture before being input into the atmosphere through the outlet pass-through opening of said inner cavity (25).

12. Cleaning machine (100) according to claim 1, characterised in that said dispenser (20) comprises at least one actuator (11) assembled between said first duct (211) and said dispensing tube (30), wherein said actuator (11) adjusts a fluid flow rate of said liquid product (115).

13. Cleaning machine (100) according to claim 1, characterised in that said outlet pass-through opening (183) may be arranged in any point of the container (190).
